(19) United States
(12) Patent Application Publication
(10) Pub. No.: US 2017/0055191 A1
(43) Pub. Date: Feb. 23, 2017

(54) BASE STATION APPARATUS AND SYSTEM

(71) Applicant: FUJITSU LIMITED, Kawasaki-shi (JP)

(72) Inventors: Yuki SHINADA, Saitama (JP); Kazunari KOBAYASHI, Yokohama (JP); Yuya MURAKAMI, Yokohama (JP)

(21) Appl. No.: 15/346,290

(22) Filed: Nov. 8, 2016

Related U.S. Application Data
(63) Continuation of application No. PCT/JP2014/063256, filed on May 19, 2014.

(51) Int. Cl. H04W 36/04; H04W 36/18

(52) U.S. Cl. CPC H04W 36/04; H04W 36/18; H04W 36/023

(57) ABSTRACT

A base station apparatus includes a memory; and a processor coupled to the memory. The processor is configured to: acquire a measurement report indicating a measurement result at a terminal apparatus connected to a first cell and a second cell, the terminal apparatus performing communication through a first bearer set in the first cell; and set in the second cell, a second bearer duplicated from the first bearer when the measurement report satisfies a first condition, based on the acquired measurement report, and switch a bearer of communication of the terminal apparatus from the first bearer to the second bearer when the measurement report satisfies a second condition different from the first condition.

### CROSS REFERENCE TO RELATED APPLICATIONS

This application is a continuation application of International Application PCT/JP2014/063256 filed on May 19, 2014 and designating the U.S., the entire contents of which are incorporated herein by reference.

### FIELD

The embodiments discussed herein are related to a base station and a system.

### BACKGROUND

Conventionally, communications systems of Long Term Evolution (LTE) etc. are known. A technique of preliminarily setting a bearer as a switching destination at the time of handover of a mobile device is known (see, e.g., Japanese Laid-Open Patent Publication No. 2013-223218). A technique of preliminarily selecting a cell to be accessed at the time of transition of a mobile device from an idle state to an active state is known (see, e.g., International Publication No. WO 2008/023609).

### SUMMARY

According to an aspect of an embodiment, a base station apparatus includes a memory; and a processor coupled to the memory. The processor is configured to: acquire a measurement report indicating a measurement result at a terminal apparatus connected to a first cell and a second cell, the terminal apparatus performing communication through a first bearer set in the first cell; and set in the second cell, a second bearer duplicated from the first bearer when the measurement report satisfies a first condition, based on the acquired measurement report, and switch a bearer of communication of the terminal apparatus from the first bearer to the second bearer when the measurement report satisfies a second condition different from the first condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a system according to a first embodiment;

FIG. 1B is a diagram of an example of signal flow in the system depicted in FIG. 1A;

FIG. 2A is a diagram of an example of a communications system according to a second embodiment;

FIG. 2B is a diagram of an example of protocol architecture;

FIGS. 3A and 3B are diagrams of an example of bearer switching;

FIG. 3C is a diagram of an example of a protocol stack of U-Plane;

FIG. 4 is a diagram of an example of operation of a communications system;

FIG. 5 is a diagram of an example of threshold values;

FIG. 6A is a diagram of an example of configurations of apparatuses of the communications system;

FIG. 6B is a diagram of an example of signal flow in the configurations of apparatuses of the communications system depicted in FIG. 6A;

FIG. 7A is a diagram of an example of hardware configuration of base stations;

FIG. 7B is a diagram of an example of signal flow in the hardware configuration of the base stations depicted in FIG. 7A;

FIG. 8A is a diagram of an example of hardware configuration of a mobile device;

FIG. 8B is a diagram of an example of signal flow in the hardware configuration of the mobile device depicted in FIG. 8A;

FIG. 9 is a diagram of an example of information monitored by a radio wave status monitoring unit;

FIGS. 10A and 10B are sequence diagrams of an example of a radio wave status management operation;

FIG. 11 is a sequence diagram of an example of a bearer duplicating operation;

FIG. 12 is a sequence diagram of an example of data transfer after bearer duplication;

FIG. 13 is a sequence diagram of an example of a data buffering operation;

FIG. 14 is a sequence diagram of an example of a bearer switching operation;

FIG. 15 is a sequence diagram of an example of a duplicated bearer releasing operation;

FIG. 16 is a flowchart (part one) of an example of a process by a macro-cell base station;

FIG. 17 is a flowchart (part two) of an example of the process by the macro-cell base station;

FIG. 18 is a flowchart (part three) of an example of the process by the macro-cell base station;

FIG. 19 is a flowchart (part one) of an example of a process by the macro-cell base station according to a third embodiment; and

FIG. 20 is a flowchart (part two) of an example of the process by the macro-cell base station according to the third embodiment.

### DESCRIPTION OF THE EMBODIMENT(S)

Embodiments of a base station and a system according to the present invention will be described in detail with reference to the accompanying drawings.

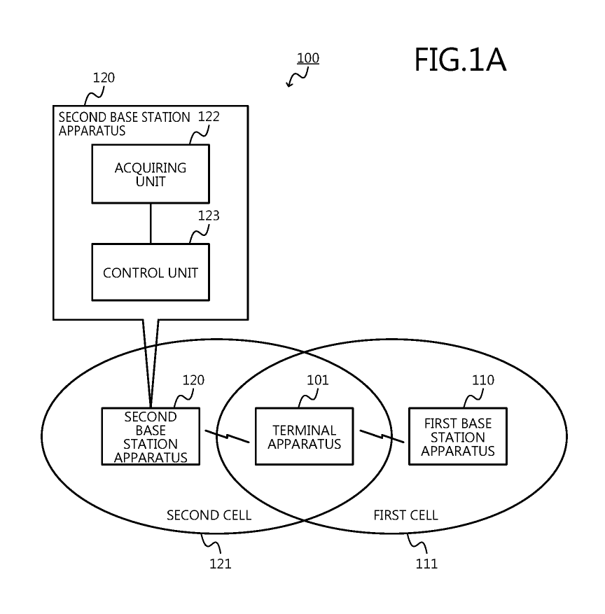

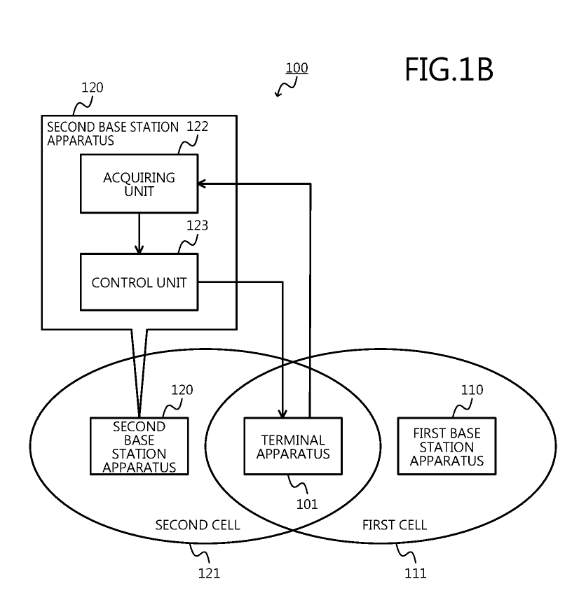

FIG. 1A is a diagram of an example of a system according to a first embodiment. FIG. 1B is a diagram of an example of signal flow in the system depicted in FIG. 1A. As depicted in FIGS. 1A and 1B, a system 100 according to the first embodiment includes a first base station apparatus 110, a second base station apparatus 120, and a terminal apparatus 101.

A first cell 111 is a cell of the first base station apparatus 110. A second cell 121 is a cell of the second base station apparatus 120. The first cell 111 is a cell at least partially overlapping the second cell 121. For example, the first cell 111 may be contained in the second cell 121.

The terminal apparatus 101 is located in an overlapping portion of the first cell 111 and the second cell 121 and is connected to the first cell 111 and the second cell 121 at the same time. It is assumed that the terminal apparatus 101 performs communication through a first bearer set in the first cell 111. In this case, the terminal apparatus 101 may perform communication through another bearer set in the second cell 121 at the same time.

The second base station apparatus 120 is a base station apparatus that manages the first cell 111 and the second cell 121, for example. The second base station apparatus 120 includes an acquiring unit 122 and a control unit 123.

The acquiring unit 122 acquires a measurement report indicating a measurement result at the terminal apparatus 101. For example, the acquiring unit 122 acquires wireless quality information concerning wireless quality of the terminal apparatus 101 in the first cell 111. The wireless quality information concerning wireless quality is information indicating wireless quality, for example. The wireless quality is received radio wave strength such as a received signal strength indicator (RSSI), for example. The acquiring unit 122 outputs the acquired wireless quality information to the control unit 123.

For example, the acquiring unit 122 directly receives the wireless quality information wirelessly transmitted from the terminal apparatus 101 as in the examples depicted in FIGS. 1A and 1B. Alternatively, the acquiring unit 122 may acquire the wireless quality information from the terminal apparatus 101 through the first base station apparatus 110, for example.

Based on the wireless quality information output from the acquiring unit 122, the control unit 123 switches the bearer used for the communication of the terminal apparatus 101. For example, if the wireless quality of the first base station apparatus 110 in the terminal apparatus 101 goes below a first predetermined value (satisfies a first condition), the control unit 123 sets in the second cell 121, a second bearer duplicated from the first bearer of the terminal apparatus 101 set in the first cell 111.

If the wireless quality of the first base station apparatus 110 in the terminal apparatus 101 goes below a second predetermined value (satisfies a second condition), the control unit 123 switches the bearer of the communication of the terminal apparatus 101 from the first bearer to the second bearer. As a result, the cell used for the communication of the terminal apparatus 101 is switched from the first cell 111 to the second cell 121. The second predetermined value is a value lower than the first predetermined value.

In this way, according to the first embodiment, if degradation of the wireless quality of the first cell 111 in the terminal apparatus 101 is detected, the bearer of the terminal apparatus 101 established in the first cell 111 may be duplicated in the second cell 121. If further degradation of the wireless quality of the first cell 111 in the terminal apparatus 101 is detected, the bearer used for the communication of the terminal apparatus 101 may be switched to the duplicated bearer.

As a result, for example, even without moving the bearer at the time of cell switching, the cell switching may be made by switching the bearer to be used to the duplicated bearer. Therefore, the cell switching may be made in a short time and decreases in throughput may be suppressed at the time of the cell switching.

Although the second base station apparatus 120 includes the acquiring unit 122 and the control unit 123 in the configuration described above, the first base station apparatus 110 may include the acquiring unit 122 and the control unit 123.

Although the wireless quality information is information indicating wireless quality in the case described above, the wireless quality information may be information indicating that the wireless quality information concerning wireless quality is equal to or less than the first predetermined value, information indicating that the wireless quality information concerning wireless quality is equal to or less than the second predetermined value, etc.

If the wireless quality of the first cell 111 in the terminal apparatus 101 falls below the first predetermined value and the duplicated bearer is set in the second cell 121, the control unit 123 may control buffering. In particular, the control unit 123 may provide control such that duplicated data of data transmitted in the first cell 111 through the first bearer to the terminal apparatus 101 is transmitted from the first base station apparatus 110 to the second base station apparatus 120 so as to buffer the duplicated data at the second base station apparatus 120.

In this case, if the wireless quality of the first cell 111 in the terminal apparatus 101 falls below the second predetermined value and the bearer used for the communication of the terminal apparatus 101 is switched to the duplicated bearer, the control unit 123 provides the following control. In particular, the control unit 123 transmits the duplicated data buffered at the second base station apparatus 120 through the second bearer to the terminal apparatus 101. As a result, the data transmission through the second bearer may be started in a relatively short time at the time of bearer switching. Therefore, decreases in throughput may be suppressed at the time of the cell switching.

In this case, after switching the bearer used for the communication of the terminal apparatus 101 to the duplicated bearer, the control unit 123 may cause the second base station apparatus 120 to transmit the duplicated data while buffering data for the terminal apparatus 101 received from another communication apparatus. The other communication apparatus is a higher-level apparatus of the second base station apparatus 120, for example.

After completing the transmission of the duplicated data, the control unit 123 causes the second base station apparatus 120 to start transmitting the data for the terminal apparatus 101 received and buffered from the other communication apparatus. This enables sequence consistency to be guaranteed between the data (duplicated data) until the wireless quality of the first cell 111 in the terminal apparatus 101 falls below the second predetermined value and the data after the wireless quality of the first cell 111 in the terminal apparatus 101 falls below the second predetermined value.

The control unit 123 may define the duplicated data transmitted by the second base station apparatus 120 after the bearer switching as the duplicated data until the time point at which the wireless quality of the first cell 111 in the terminal apparatus 101 is not below the second predetermined value, among the buffered duplicated data. As a result, the data having a high possibility of being normally received by the terminal apparatus 101 from the first cell 111 may be prevented from being transmitted again from the second cell 121.

In this case, if the wireless quality of the first cell 111 in the terminal apparatus 101 is below the first predetermined value and is not below the second predetermined value, the control unit 123 may provide control of sequentially deleting the duplicated data buffered by the second base station apparatus 120. As a result, an amount of a memory used for buffering at the second base station apparatus 120 may be reduced.

If the wireless quality of the first cell 111 in the terminal apparatus 101 falls below the first predetermined value and then exceeds a third predetermined value, the control unit 123 may delete the second bearer set in the second cell 121. The third predetermined value is a value equal to or greater than the first predetermined value. As a result, if the wireless quality of the first cell 111 in the terminal apparatus 101 improves, a radio resource in the second cell 121 may be released to increase the usage efficiency of the radio resources.

If the wireless quality of the first cell 111 in the terminal apparatus 101 falls below the first predetermined value and then exceeds the third predetermined value, the control unit 123 may provide control of stopping the transmission of the duplicated data from the first base station apparatus 110 to the second base station apparatus 120. As a result, if the wireless quality of the first cell 111 at the terminal apparatus 101 improves, traffic between the first base station apparatus 110 and the second base station apparatus 120 may be reduced.

A modification example is described. The acquiring unit 122 may acquire information concerning a movement speed of the terminal apparatus 101 and the wireless quality of the first cell 111 at the terminal apparatus 101. This information is, for example, information indicating the movement speed and the wireless quality of the terminal apparatus 101. In this case, when the movement speed of the terminal apparatus 101 exceeds a predetermined speed, the control unit 123 sets in the second cell 121, the second bearer duplicated from the first bearer of the terminal apparatus 101 set in the first cell 111.

If the wireless quality of the first base station apparatus 110 at the terminal apparatus 101 falls below a predetermined value (e.g., the second predetermined value described above), the control unit 123 switches the bearer of the communication of the terminal apparatus 101 from the first bearer to the second bearer. As a result, the cell used for the communication of the terminal apparatus 101 is switched from the first cell 111 to the second cell 121. The second predetermined value is a value lower than the first predetermined value.

As described above, in the first embodiment, if an increase in the movement speed of the terminal apparatus 101 is detected, the bearer of the terminal apparatus 101 established in the first cell 111 may be duplicated in the second cell 121. If degradation in the wireless quality of the first cell 111 at the terminal apparatus 101 is detected, the bearer used for the communication of the terminal apparatus 101 is switched to the duplicated bearer.

As a result, the bearer of the terminal apparatus 101 may be duplicated in the second cell 121 before degradation in the wireless quality of the first cell 111 at the terminal apparatus 101 due to movement of the terminal apparatus 101. Therefore, for example, even without moving the bearer at the time of cell switching, the cell switching may be made by switching the bearer to be used to the duplicated bearer. Therefore, cell switching may be made in a short time and decreases in throughput may be suppressed at the time of the cell switching.

Although the information acquired by the acquiring unit 122 is information indicating movement speed in the case described above, the information acquired by the acquiring unit 122 may be information indicating that the movement speed exceeds the predetermined speed, etc.

If the movement speed of the terminal apparatus 101 exceeds the predetermined speed and the wireless quality falls below the first predetermined value, the control unit 123 may set in the second cell 121, the second bearer duplicated from the first bearer of the terminal apparatus 101 set in the first cell 111.

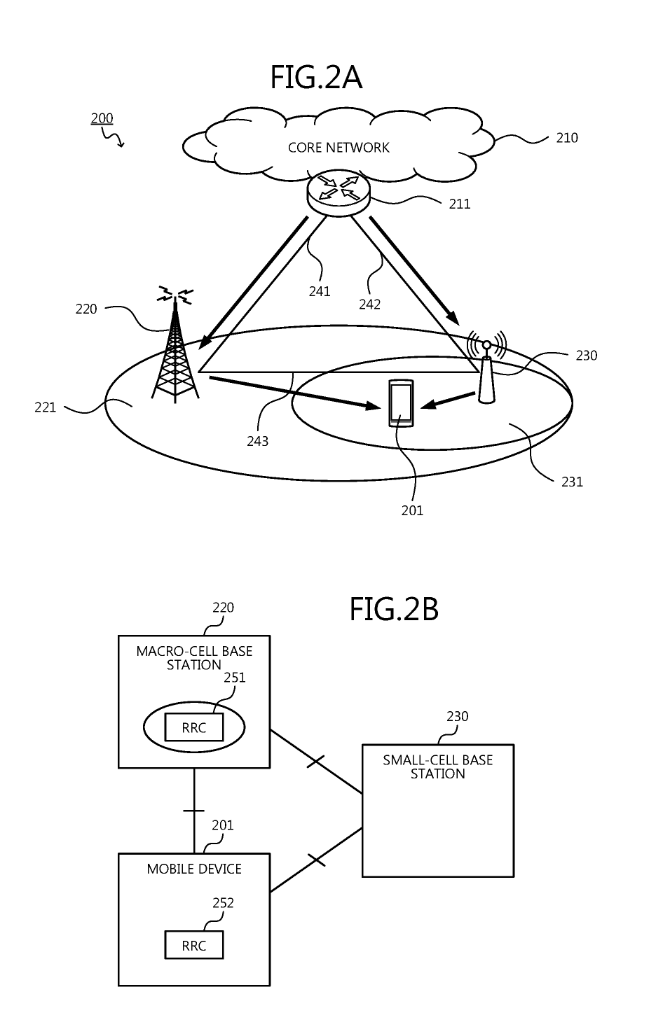

FIG. 2A is a diagram of an example of a communications system according to a second embodiment. As depicted in FIG. 2A, a communications system 200 according to the second embodiment includes a core network 210, a macro-cell base station 220, a small-cell base station 230, and a mobile device 201. The communications system 200 is a communications system of LTE, etc. prescribed by 3rd Generation Partnership Project (3GPP).

The system 100 depicted in FIGS. 1A and 1B may be implemented by the communications system 200, for example. In this case, the first base station apparatus 110 depicted in FIGS. 1A and 1B may be implemented by the macro-cell base station 220, for example. The second base station apparatus 120 depicted in FIGS. 1A and 1B may be implemented by the small-cell base station 230, for example. The terminal apparatus 101 depicted in FIGS. 1A and 1B may be implemented by the mobile device 201, for example.

A higher-level apparatus 211 is a communication apparatus included in the core network 210 and is a higher-level apparatus 211 of the macro-cell base station 220 and the small-cell base station 230. For example, the higher-level apparatus 211 is a serving gateway (SGW).

A macro cell 221 is a cell formed by the macro-cell base station 220. The macro-cell base station 220 is an evolved Node B (eNB), for example. A small cell 231 is a cell formed by the small-cell base station 230. The small cell 231 is, for example, a cell having a smaller area as compared to the macro cell 221, such as a femtocell, a picocell, and a nanocell.

The macro-cell base station 220 and the small-cell base station 230 are respectively connected through S1 interfaces 241, 242 to the higher-level apparatus 211 of the core network 210. The macro-cell base station 220 and the small-cell base station 230 are connected through an X2 interface 243 to each other.

The mobile device 201 is User Equipment (UE: user terminal), for example. The mobile device 201 may be connected to the macro-cell base station 220 and the small-cell base station 230. The mobile device 201 may concurrently communicate with the macro-cell base station 220 and the small-cell base station 230 to receive different data (e.g., U-Plane data) from the macro-cell base station 220 and the small-cell base station 230, respectively.

In this case, the higher-level apparatus 211 of the core network 210 transmits different data to the macro-cell base station 220 and the small-cell base station 230, respectively. For example, the mobile device 201 concurrently communicates at different frequencies with the macro-cell base station 220 and the small-cell base station 230, respectively.

The higher-level apparatus 211 may select a transfer path of data transmitted to the mobile device 201 depending on a type of the data. For example, the higher-level apparatus 211 transmits data of voice communication, etc. requiring reliable communication rather than high throughput, through the macro-cell base station 220 to the mobile device 201. The voice communication is Voice over IP (VoIP) or Voice over LTE (VoLTE), for example. The higher-level apparatus 211 transmits communication such as streaming requiring high throughput, through the small-cell base station 230 to the mobile device 201.

FIG. 2B is a diagram of an example of protocol architecture. A radio resource control (RRC) 251 depicted in FIG. 2B is a control unit of RRC in the macro-cell base station 220. An RRC 252 is a control unit of RRC in the mobile device 201.

The RRC between the macro-cell base station 220 and the mobile device 201 is respectively terminated by the RRCs 251, 252. The RRC of communication of the mobile device 201 through the small-cell base station 230 is also terminated by the RRCs 251, 252. In this way, the RRC 251 of the macro-cell base station 220 manages both a U-Plane route of the macro cell 221 and a U-Plane route of the small cell 231.

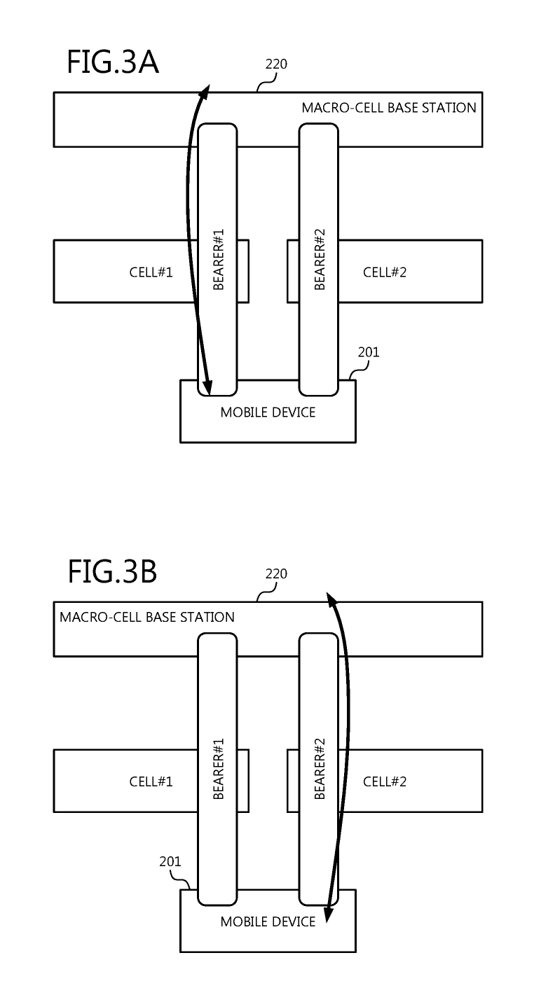

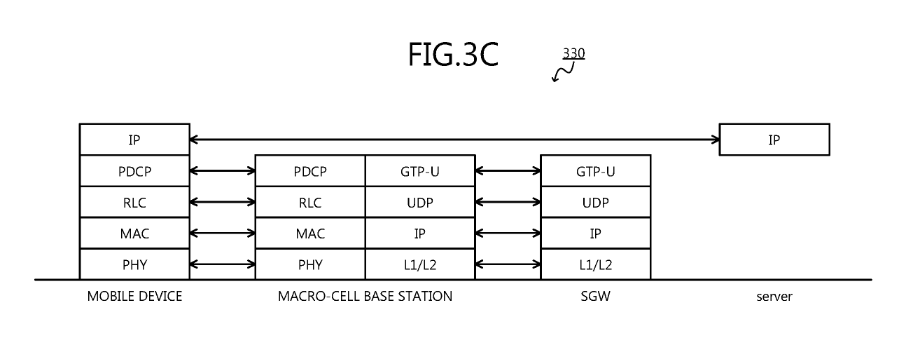

FIGS. 3A and 3B are diagrams of an example of bearer switching. As depicted in FIGS. 3A and 3B, for example, a bearer #1 using a cell #1 and a bearer #2 using a cell #2 are set between the macro-cell base station 220 and the mobile device 201. The macro-cell base station 220 and the mobile device 201 perform bearer switching from a state of performing communication by using the bearer #1 as depicted in FIG. 3A to a state of performing communication by using the bearer #2 as depicted in FIG. 3B, for example.

By setting multiple bearers for the mobile device 201 and switching the bearer to be used at the time of cell switching, communication may be continued. As a result, the cell switching may be made in a short time as compared to a handover, for example.

In the second embodiment, multiple bearers are set by duplicating the bearer of the mobile device 201 going through the small-cell base station 230, and the bearer to be used is switched from the bearer of the small-cell base station 230 to the bearer of the macro-cell base station 220. As a result, the cell switching may be made in a short time.

FIG. 3C is a diagram of an example of a protocol stack of U-Plane. A protocol stack 330 depicted in FIG. 3C is a protocol stack of U-Plane in Evolved Universal Terrestrial Radio Access Network (E-UTRAN), for example. The duplication of the bearer described above may be performed on a Packet Data Convergence Protocol (PDCP) layer, for example.

A mobile device depicted in FIG. 3C is the mobile device 201, for example. A macro-cell base station depicted in FIG. 3C is the macro-cell base station 220, for example. An SGW depicted in FIG. 3C is the higher-level apparatus 211, for example. A server depicted in FIG. 3C is a server disposed in the core network 210 to communicate with the mobile device 201.

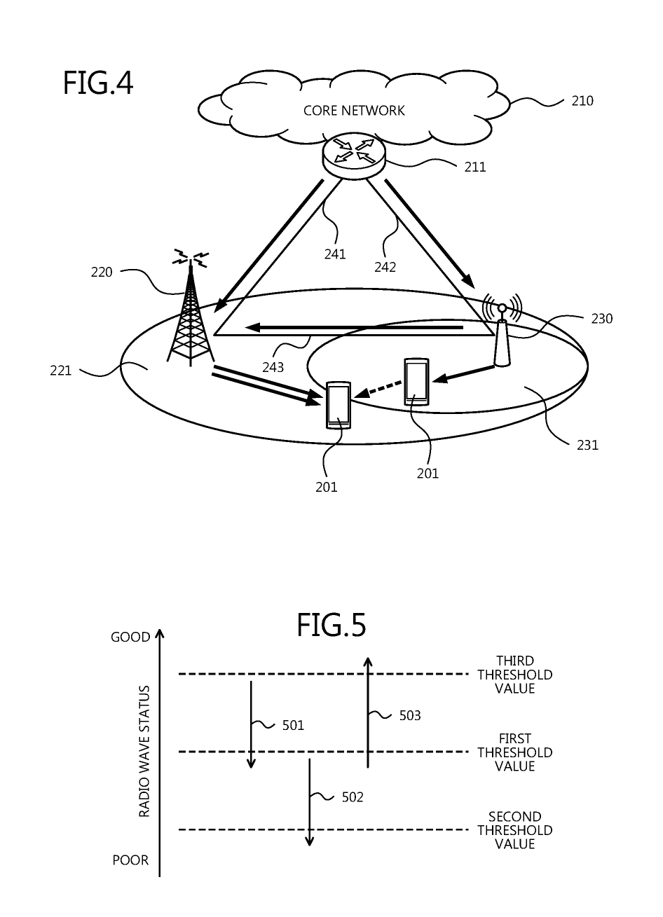

FIG. 4 is a diagram of an example of operation of the communications system. In FIG. 4, portions identical to those depicted in FIG. 2A are denoted by the same reference numerals used in FIG. 2A and will not be described.

The macro-cell base station 220 monitors a radio wave status measurement result transmitted from the mobile device 201, thereby monitoring the radio wave status of communication using the small-cell base station 230. The mobile device 201 transmits a radio wave status measurement result to the macro-cell base station 220 at the time of position registration, for example. The macro-cell base station 220 periodically makes a radio wave status measurement request to the mobile device 201, and the mobile device 201 transmits a radio wave status measurement result to the macro-cell base station 220 in response to the measurement request.

If the radio wave status measurement result from the mobile device 201 is blow a first threshold value (bearer setting threshold value), the macro-cell base station 220 requests bearer information related to the mobile device 201 from the small-cell base station 230. The macro-cell base station 220 sets the same bearer as the small-cell base station 230 in the macro-cell base station 220.

The small-cell base station 230 duplicates data received from the core network 210 for transmission to each of the mobile device 201 and the macro-cell base station 220. The small-cell base station 230 performs data transfer to the macro-cell base station 220 concurrently with data transmission to the mobile device 201. This data transfer is performed through the X2 interface 243, for example.

The macro-cell base station 220 buffers the data transferred from the small-cell base station 230 until a bearer switching. The macro-cell base station 220 periodically monitors radio wave status and deletes unnecessary buffering data if the radio wave status measurement result does not fall below a second threshold value (bearer switching threshold value).

If the radio wave status measurement result falls below the second threshold value (bearer switching threshold value), the macro-cell base station 220 performs the bearer switching by making a bearer switching request to the core network 210 and transmits the buffering data to the mobile device 201. In this case, the macro-cell base station 220 transmits the data to the mobile device 201 while guaranteeing sequence consistency between the data transferred from the small-cell base station 230 and the data transmitted from the core network 210. Therefore, after the bearer switching, the macro-cell base station 220 transmits the data transmitted from the core network 210 after completion of transmission of the buffering data.

If the radio wave status measurement result falls below a third threshold value (bearer deletion threshold value), the macro-cell base station 220 deletes the bearer set at the macro-cell base station 220 and deletes the buffering data. If the small-cell base station 230 has started duplicating and transferring data, the macro-cell base station 220 makes a stop request requesting the small-cell base station 230 to stop the duplication and transfer. The deletion of the bearer and the deletion of the buffering data are performed after the duplication and transfer are stopped by the stop request, for example.

As a result, the beater switching from the small-cell base station 230 to the macro-cell base station 220 may be performed without stopping the data transmission to the mobile device 201. Therefore, decreases in throughput due to cell switching may be suppressed. Since the bearer switching may be performed without transmitting the same data to a wireless segment, the load of the wireless segment may be reduced.

FIG. 5 is a diagram of an example of the threshold values. In FIG. 5, a vertical axis indicates radio wave status. The radio wave status is received radio wave strength such as the RSSI. The higher the received radio wave strength is, the better the radio wave status is, and the lower the received radio wave strength is, the worse the radio wave status is.

As depicted in FIG. 5, the first, second, and third threshold values have a relationship of the second threshold value<the first threshold value<the third threshold value, for example. The first threshold value may be equal to the third threshold value. The first, second, and third threshold values are parameters that may be changed arbitrarily, and may be parameters that may be set individually by a communication carrier, for example.

The first threshold value is a threshold value for detecting degradation of the radio wave status of the small-cell base station 230 and setting (duplicating) the bearer at the macro-cell base station 220 in advance. The second threshold value is a threshold value for detecting degradation of the radio wave status of the small-cell base station 230 and switching to the macro-cell base station 220. The third threshold value is a threshold value for detecting improvement of the radio wave status of the small-cell base station 230 and releasing the bearer set at the macro-cell base station 220.

Radio wave status changes 501 to 503 indicate changes in the radio wave status reported from the mobile device 201. For example, if the radio wave status falls below the first threshold value as indicated by the radio wave status change 501, it may be determined that the communication status at the small-cell base station 230 has degraded. In this case, the small-cell base station 230 starts duplicating and transferring data to the macro-cell base station 220. Meanwhile, the macro-cell base station 220 duplicates the bearer of the small-cell base station 230 (ensures a radio resource) at the macro-cell base station 220 and starts buffering the transfer data from the small-cell base station 230.

If the radio wave status falls below the second threshold value as indicated by the radio wave status change 502, it may be determined that further degradation of the communication status in the small-cell base station 230 has made communication in the small-cell base station 230 difficult. In this case, the macro-cell base station 220 performs the bearer switching to switch the bearer of the mobile device 201 from the small-cell base station 230 to the macro-cell base station 220. As a result, the data transmission to the mobile device 201 may be continued.

If the radio wave status exceeds the third threshold value as indicated by the radio wave status change 503, it may be determined that the communication status in the small-cell base station 230 has improved. In this case, the macro-cell base station 220 deletes the bearer set due to the radio wave status change 501 (releases the radio resource) and deletes the buffering data. The small-cell base station 230 stops the duplication and transfer of the data and continues the data transmission to the mobile device 201.

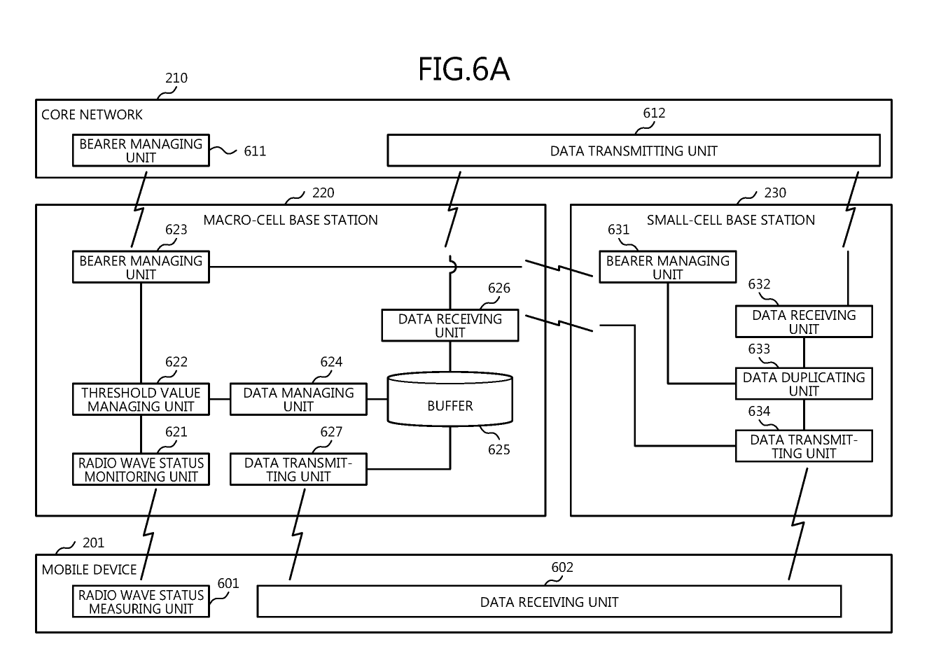

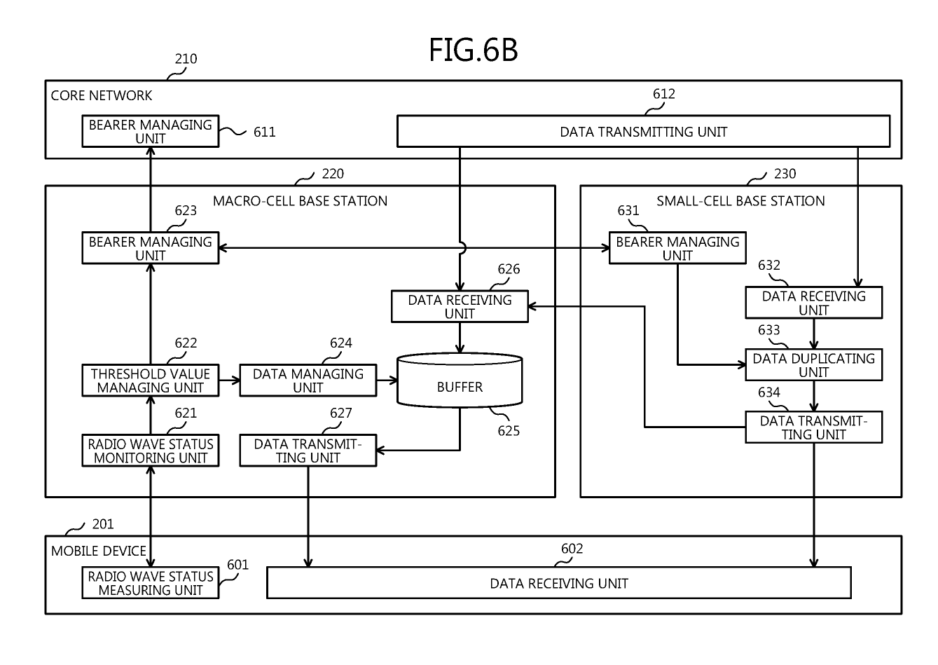

FIG. 6A is a diagram of an example of configurations of apparatuses of the communications system. FIG. 6B is a diagram of an example of signal flow in the configurations of apparatuses of the communications system depicted in FIG. 6A. As depicted in FIGS. 6A and 6B, the core network 210 includes a bearer managing unit 611 and a data transmitting unit 612.

The bearer managing unit 611 manages the U-Plane routes of the macro-cell base station 220 and the small-cell base station 230. The data transmitting unit 612 transmits data to the macro-cell base station 220 and the small-cell base station 230.

The macro-cell base station 220 includes a radio wave status monitoring unit 621, a threshold value managing unit 622, a bearer managing unit 623, a data managing unit 624, a buffer 625, a data receiving unit 626, and a data transmitting unit 627.

The radio wave status monitoring unit 621 periodically transmits a radio wave status measurement request to the mobile device 201. The radio wave status monitoring unit 621 receives a radio wave status measurement result transmitted from the mobile device 201 in response to the measurement request. The radio wave status monitoring unit 621 outputs the received radio wave status measurement result to the threshold value managing unit 622.

The threshold value managing unit 622 stores the first, second, and third threshold values described above. The threshold value managing unit 622 compares the received radio wave strength indicated by the radio wave status measurement result output from the radio wave status monitoring unit 621 with the threshold values and outputs a comparison result to the bearer managing unit 623 and the data managing unit 624.

The bearer managing unit 623 manages the bearers of the macro-cell base station 220 and the small-cell base station 230. The bearer managing unit 623 performs the bearer setting of the macro-cell base station 220 and makes the bearer switching request to the core network 210, based on the comparison result output from the threshold value managing unit 622.

The data managing unit 624 deletes the data buffered in the buffer 625 based on the comparison result output from the threshold value managing unit 622. The data managing unit 624 manages the transmission of the data buffered in the buffer 625 based on the comparison result output from the threshold value managing unit 622.

The buffer 625 buffers data output from the data receiving unit 626. The buffer 625 deletes the buffering data and outputs the buffering data to the data transmitting unit 627, under the control of the data managing unit 624.

The data receiving unit 626 receives data from the small-cell base station 230. The data receiving unit 626 receives data from the core network 210. The data receiving unit 626 outputs the received data to the buffer 625. The data transmitting unit 627 transmits data output from the buffer 625 to the mobile device 201.

The acquiring unit 122 depicted in FIGS. 1A and 1B may be implemented by the radio wave status monitoring unit 621, for example. The control unit 123 depicted in FIGS. 1A and 1B may be implemented by the threshold value managing unit 622, the bearer managing unit 623, the data managing unit 624, the buffer 625, the data receiving unit 626, and the data transmitting unit 627, for example.

The small-cell base station 230 includes a bearer managing unit 631, a data receiving unit 632, a data duplicating unit 633, and a data transmitting unit 634. The bearer managing unit 631 receives a bearer information request from the macro-cell base station 220 and then transmits the bearer information related to the mobile device 201 to the macro-cell base station 220.

The bearer managing unit 631 receives a bearer deletion notification from the macro-cell base station 220 and then outputs to the data duplicating unit 633, a data duplication stop request requesting data duplication to be stopped. When a data transfer stop response indicating the stop of data transfer is output from the data duplicating unit 633, the bearer managing unit 631 transmits to the macro-cell base station 220, data transfer stop notification giving notification of the stop of data transfer.

The data receiving unit 632 receives data from the core network 210 and outputs the received data to the data duplicating unit 633.

The data duplicating unit 633 duplicates the received data from the core network 210 output from the data receiving unit 632 into two pieces of data, i.e., the data to the mobile device 201 and the data to the macro-cell base station 220. The data duplicating unit 633 outputs the duplicated data to the data transmitting unit 634. The data transmitting unit 634 transmits the data output from the data duplicating unit 633 to the mobile device 201 and the macro-cell base station 220.

The mobile device 201 includes a radio wave status measuring unit 601 and a data receiving unit 602. The radio wave status measuring unit 601 measures the radio wave status based on a reception result of a wireless signal during communication at the time of position registration, for example, and transmits a radio wave status measurement result to the macro-cell base station 220. Additionally, based on a radio wave status measurement instruction from the macro-cell base station 220, the radio wave status measuring unit 601 measures radio wave status based on a reception result of a wireless signal and transmits a radio wave status measurement result to the macro-cell base station 220.

The data receiving unit 602 receives data from the macro-cell base station 220 and the small-cell base station 230.

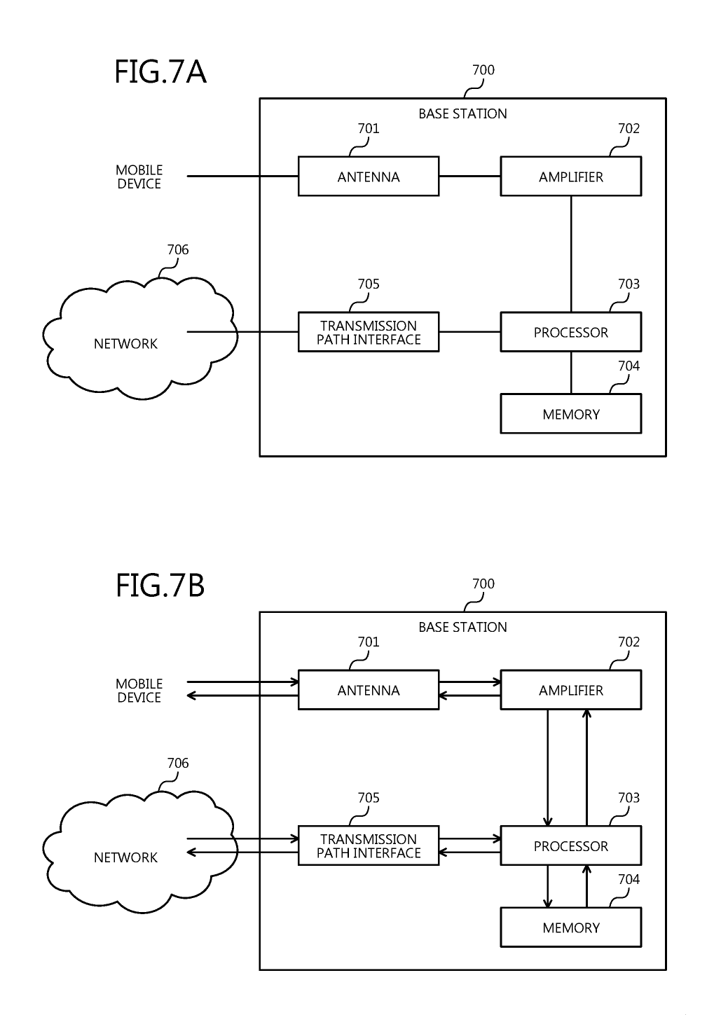

FIG. 7A is a diagram of an example of hardware configuration of the base stations. FIG. 7B is a diagram of an example of signal flow in the hardware configuration of the base stations depicted in FIG. 7A. The macro-cell base station 220 and the small-cell base station 230 may each be implemented by a base station 700 depicted in FIGS. 7A and 7B. The base station 700 includes an antenna 701, an amplifier 702, a processor 703, a memory 704, and a transmission path interface 705.

The antenna 701 receives a signal wirelessly transmitted from another wireless communications apparatus (e.g., the mobile device 201) and outputs the received signal to the amplifier 702. The antenna 701 wirelessly transmits a signal output from the amplifier 702 to another wireless communications apparatus.

The amplifier 702 amplifies and outputs the signal output from the antenna 701 to the processor 703. The amplifier 702 amplifies and outputs the signal output from the processor 703 to the antenna 701.

The processor 703 provides overall control of the base station 700. For example, the processor 703 executes a transmission process of generating a signal to be transmitted to another wireless communications apparatus and outputting the signal to the amplifier 702. The processor 703 executes a reception process such as demodulation and decoding of the signal output from the amplifier 702.

The memory 704 includes a main memory and an auxiliary memory, for example. The main memory is a random access memory (RAM), for example. The main memory is used as a work area of the processor 703. The auxiliary memory is a non-volatile memory such as a magnetic disk, an optical disk, and a flash memory, for example. In the auxiliary memory, various programs for operating the base station 700 are stored. The programs stored in the auxiliary memory are loaded to the main memory and executed by the processor 703.

The transmission path interface 705 is a communication interface for performing wired communication with a network 706, for example. For example, the transmission path interface 705 includes the Si interface with the core network 210 and the X2 interface between base stations. The transmission path interface 705 is controlled by the processor 703.

The radio wave status monitoring unit 621, the threshold value managing unit 622, the bearer managing unit 623, and the data managing unit 624 of the macro-cell base station 220 depicted in FIGS. 6A and 6B may be implemented by the antenna 701, the amplifier 702, the processor 703, and the memory 704, for example. The data receiving unit 626 and the data transmitting unit 627 of the macro-cell base station 220 depicted in FIGS. 6A and 6B may be implemented by the antenna 701, the amplifier 702, the processor 703, and the memory 704, for example. The buffer 625 of the macro-cell base station 220 depicted in FIGS. 6A and 6B may be implemented by the processor 703 and the memory 704 (auxiliary memory), for example.

The bearer managing unit 631, the data receiving unit 632, the data duplicating unit 633, and the data transmitting unit 634 of the small-cell base station 230 depicted in FIGS. 6A and 6B may be implemented by the processor 703 and the memory 704 (main memory), for example.

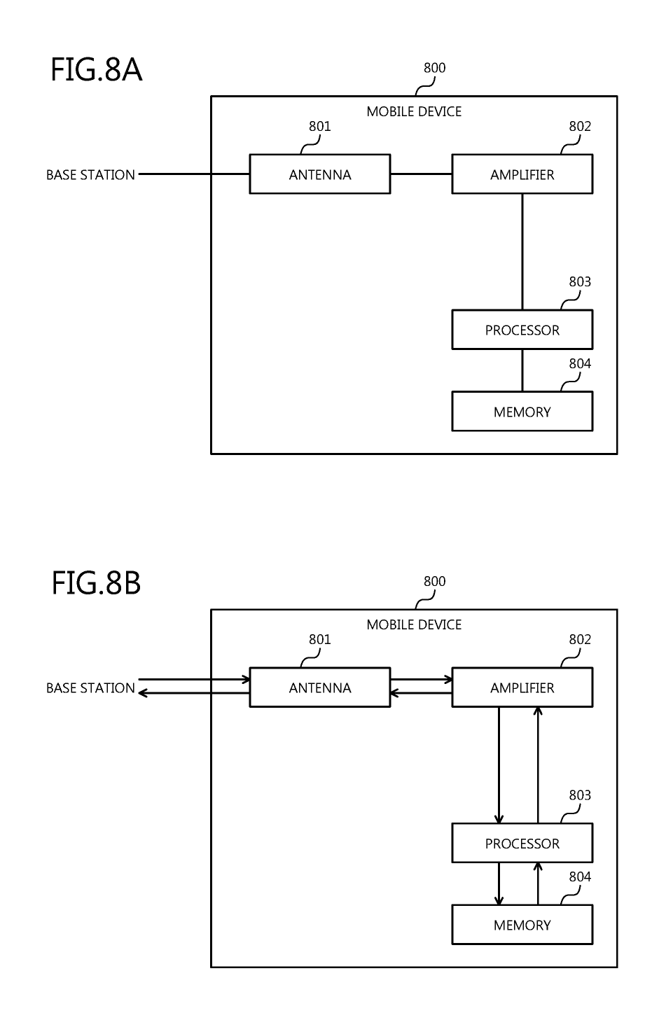

FIG. 8A is a diagram of an example of hardware configuration of the mobile device. FIG. 8B is a diagram of an example of signal flow in the hardware configuration of the mobile device depicted in FIG. 8A. The mobile device 201 may be implemented by a mobile device 800 depicted in FIGS. 8A and 8B, for example. The mobile device 800 includes an antenna 801, an amplifier 802, a processor 803, and a memory 804.

The antenna 801 receives a signal wirelessly transmitted from another wireless communications apparatus (e.g., the macro-cell base station 220 or the small-cell base station 230) and outputs the received signal to the amplifier 802. The antenna 801 wirelessly transmits a signal output from the amplifier 802 to another wireless communications apparatus.

The amplifier 802 amplifies and outputs the signal output from the antenna 801 to the processor 803. The amplifier 802 amplifies and outputs the signal output from the processor 803 to the antenna 801.

The processor 803 provides overall control of the mobile device 800. For example, the processor 803 executes a transmission process of generating a signal to be transmitted to another wireless communications apparatus and outputting the signal to the amplifier 802. The processor 803 executes a reception process such as demodulation and decoding of the signal output from the amplifier 802.

The memory 804 includes a main memory and an auxiliary memory, for example. The main memory is a RAM, for example. The main memory is used as a work area of the processor 803. The auxiliary memory is a non-volatile memory such as a magnetic disk and a flash memory, for example. In the auxiliary memory, various programs for operating the mobile device 800 are stored. The programs stored in the auxiliary memory are loaded to the main memory and executed by the processor 803.

The radio wave status measuring unit 601 and the data receiving unit 602 of the mobile device 201 depicted in FIGS. 6A and 6B may be implemented by the processor 803 and the memory 804 (main memory), for example.

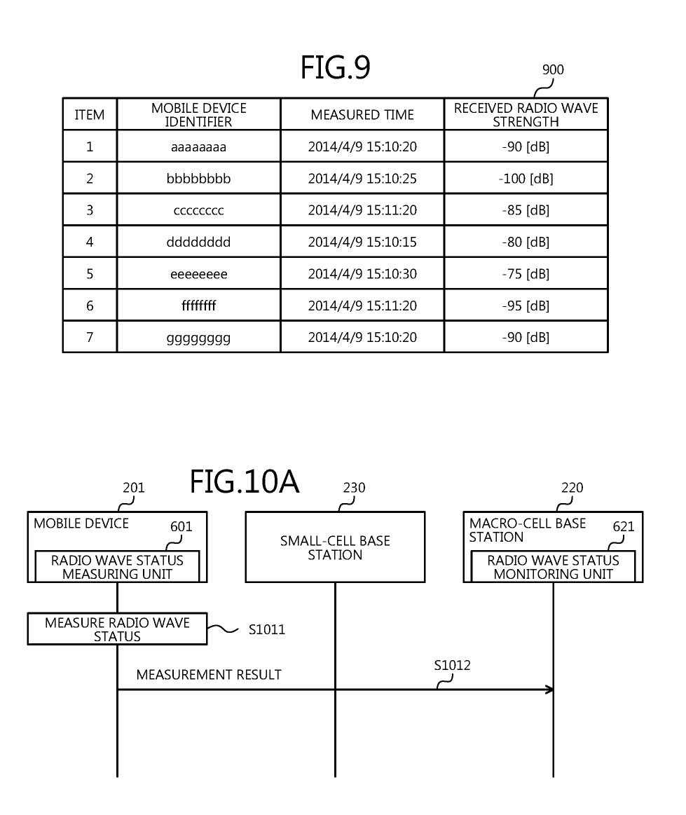

FIG. 9 is a diagram of an example of information monitored by the radio wave status monitoring unit. The radio wave status monitoring unit of the macro-cell base station 220 manages a radio wave status monitoring table 900 depicted in FIG. 9, for example. The radio wave status monitoring table 900 includes a mobile device identifier, a measurement time, and received radio wave strength as items.

The mobile device identifier is an identifier of an object mobile device. The measurement time is a clock time when a radio wave status measurement result is transmitted from the object mobile device. Alternatively, the measurement time may be a clock time when a radio wave status is measured by the object mobile device. The received radio wave strength is a radio wave strength [dB] measured by the object mobile device.

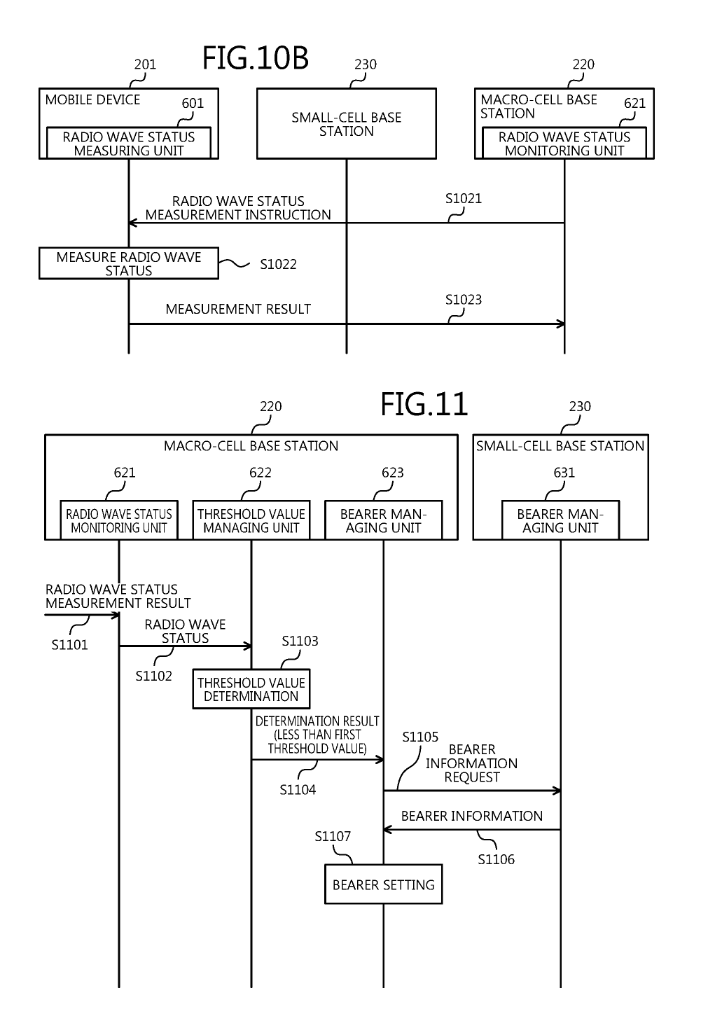

FIGS. 10A and 10B are sequence diagrams of an example of a radio wave status management operation. For the radio wave status management operation, the communications system 200 operates as in steps depicted in FIGS. 10A and 10B, for example.

A case of the mobile device 201 autonomously measuring a radio wave status will be described with reference to FIG. 10A. First, the radio wave status measuring unit 601 of the mobile device 201 measures the radio wave status based on a reception result of a wireless signal at the time of position registration, for example (step S1011).

The radio wave status measuring unit 601 transmits the measurement result of step S1011 to the macro-cell base station 220 (step S1012). The measurement result transmitted at step S1012 is information indicating the used frequency and the received radio wave strength of the mobile device 201, for example. For this measurement result, for example, Measurement Report of RRC prescribed by 3GPP may be used. The radio wave status monitoring unit 621 of the macro-cell base station 220 stores the measurement result transmitted at step S1012 into the radio wave status monitoring table 900 along with the clock time (measurement time) of step S1012 (see, e.g., FIG. 9).

A case of the macro-cell base station 220 periodically giving an instruction for measuring the radio wave status of the mobile device 201 will be described with reference to FIG. 10B. First, the radio wave status monitoring unit 621 of the macro-cell base station 220 transmits at a periodical timing, a radio wave status measurement instruction instructing the mobile device 201 to measure the radio wave status, for example (step S1021). The radio wave status measurement instruction transmitted at step S1021 is Measurement control of RRC, for example.

Based on the radio wave status measurement instruction at step S1021, the radio wave status measuring unit 601 of the mobile device 201 measures the radio wave status based on a reception result of a wireless signal (step S1022). The radio wave status measuring unit 601 then goes to step S1023. Step S1023 is the same as step S1012 depicted in FIG. 10A.

FIG. 11 is a sequence diagram of an example of a bearer duplicating operation. For the bearer duplicating operation, the communications system 200 operates as in steps depicted in FIG. 11, for example.

First, the radio wave status monitoring unit 621 of the macro-cell base station 220 receives the radio wave status measurement result transmitted from the mobile device 201 (step S1101). Step S1101 corresponds to step S1012 depicted in FIG. 10A and step S1023 depicted in FIG. 10B, for example. The radio wave status monitoring unit 621 notifies the threshold value managing unit 622 of the radio wave status indicated by the measurement result received at step S1101 (step S1102).

The threshold value managing unit 622 makes a threshold value determination of the radio wave status (e.g., received radio wave strength) of the notification at step S1102 (step S1103). In the example depicted in FIG. 11, it is assumed that the radio wave status is less than the first threshold value. The threshold value managing unit 622 outputs to the bearer managing unit 623, a determination result indicating that the radio wave status is less than the first threshold value (step S1104).

The bearer managing unit 623 then transmits to the small-cell base station 230, a bearer information request for requesting the bearer information related to the mobile device 201 (step S1105). The bearer managing unit 631 of the small-cell base station 230 transmits the bearer information related to the mobile device 201 to the macro-cell base station 220 (step S1106).

The bearer information is information indicating Quality of Service (QOS) such as QoS Class Identifier (QCI), a PDCP sequence number, and a Radio Link Control (RLC) sequence number of a lower-level layer, for example.

The bearer managing unit 623 of the macro-cell base station 220 performs the bearer setting of the mobile device 201 based on the bearer information transmitted at step S1106 (step S1107). As a result, the bearer of the mobile device 201 set at the small-cell base station 230 is duplicated in the macro-cell base station 220.

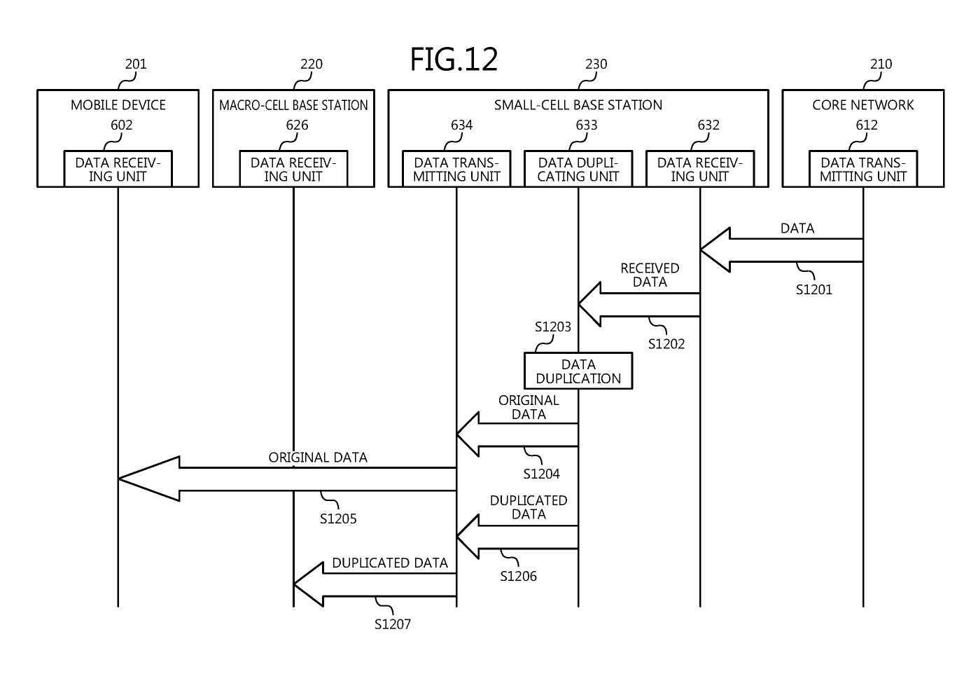

FIG. 12 is a sequence diagram of an example of data transfer after bearer duplication. After the bearer duplication operation depicted in FIG. 11, the data transfer to the mobile device 201 is performed in the communications system 200 as in steps depicted in FIG. 12, for example.

The data transmitting unit 612 of the core network 210 transmits data for the mobile device 201 to the small-cell base station 230 (step S1201). The data receiving unit 632 of the small-cell base station 230 outputs the received data at step S1201 to the data duplicating unit 633 (step S1202). The data duplicating unit 633 performs the data duplication of the received data output from the data receiving unit 632 (step S1203).

The data duplicating unit 633 outputs to the data transmitting unit 634, the received data (original data) output from the data receiving unit 632 (step S1204). The data transmitting unit 634 transmits the original data output at step S1204 to the mobile device 201 (step S1205). The original data transmitted at step S1205 is received by the data receiving unit 602 of the mobile device 201.

The data duplicating unit 633 outputs to the data transmitting unit 634, the data duplicated at step S1203 from the received data output from the data receiving unit 632 (step S1206). The data transmitting unit 634 then transmits to the macro-cell base station 220 the duplicated data output at the step S206 (step S1207). The duplicated data transmitted at step S1207 is received by the data receiving unit 626 of the macro-cell base station 220.

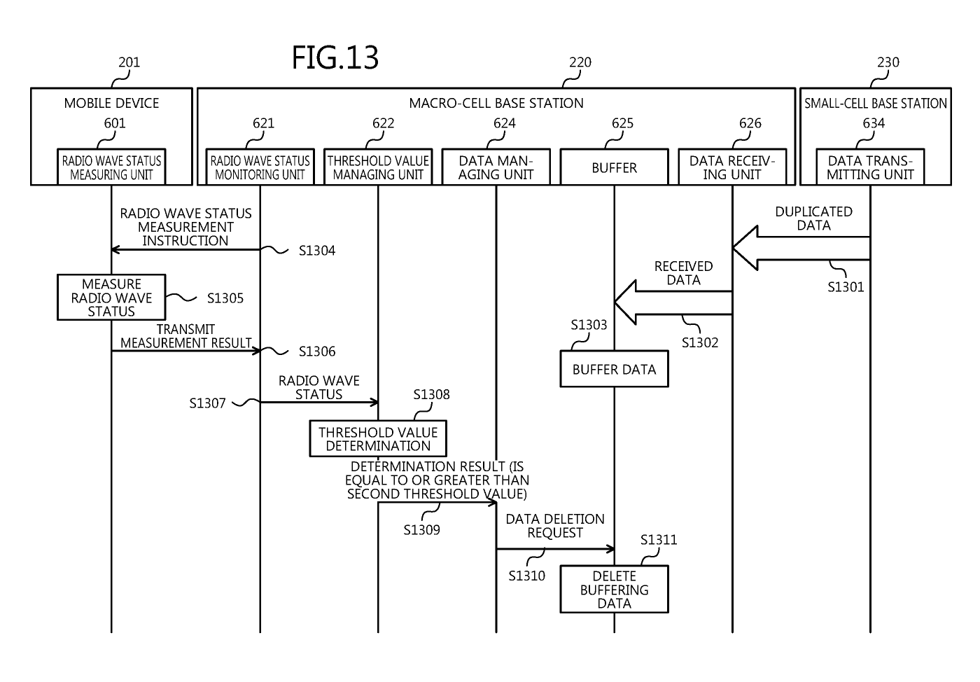

FIG. 13 is a sequence diagram of an example of a data buffering operation. When the data transfer depicted in FIG. 12 is performed, the communications system 200 operates for the data buffering operation as in steps depicted in FIG. 13, for example.

First, the data transmitting unit 634 of the small-cell base station 230 transmits the duplicated data to the macro-cell base station 220 (step S1301). Step S1301 is step corresponding to step S1207 depicted in FIG. 12, for example.

The data receiving unit 626 of the macro-cell base station 220 outputs the received data at step S1301 to the buffer 625 (step S1302). The buffer 625 buffers the data output at step S1302 (step S1303).

On the other hand, the mobile device 201 and the macro-cell base station 220 execute steps S1304 to S1306 that are the same as steps S1021 to S1023 depicted in FIG. 10B, for example. After step S1306, the radio wave status monitoring unit 621 of the macro-cell base station 220 notifies the threshold value managing unit 622 of the radio wave status indicated by the measurement result received at step S1306 (step S1307).

The threshold value managing unit 622 then makes a threshold value determination of the radio wave status of the notification at step S1307 (step S1308). In the example depicted in FIG. 13, it is assumed that the radio wave status is not below the second threshold value (is equal to or greater than the second threshold value). The threshold value managing unit 622 outputs to the data managing unit 624, a determination result indicating that the radio wave status is equal to or greater than the second threshold value (step S1309).

The data managing unit 624 outputs to the buffer 625, a data deletion request requesting the deletion of the data buffered in the buffer 625 (step S1310). The data deletion request output at step S1310 is, for example, a request for deleting the data having the reception time before the measurement time of the measurement result at step S1306 among the data buffered in the buffer 625.

The buffer 625 deletes the buffering data based on the data deletion request output at step S1310 (step S1311). In this way, the macro-cell base station 220 buffers the data transferred from the small-cell base station 230, until the bearer switching.

The macro-cell base station 220 sequentially deletes the buffering data of the period in which the radio wave status is equal to or greater than the second threshold value. In the period in which the radio wave status is equal to or greater than the second threshold value, the buffering data is highly likely to have arrived from the small-cell base station 230 to the mobile device 201 and therefore, may be deleted to improve the transmission efficiency after the bearer switching. Additionally, the used amount of the buffer 625 may be reduced.

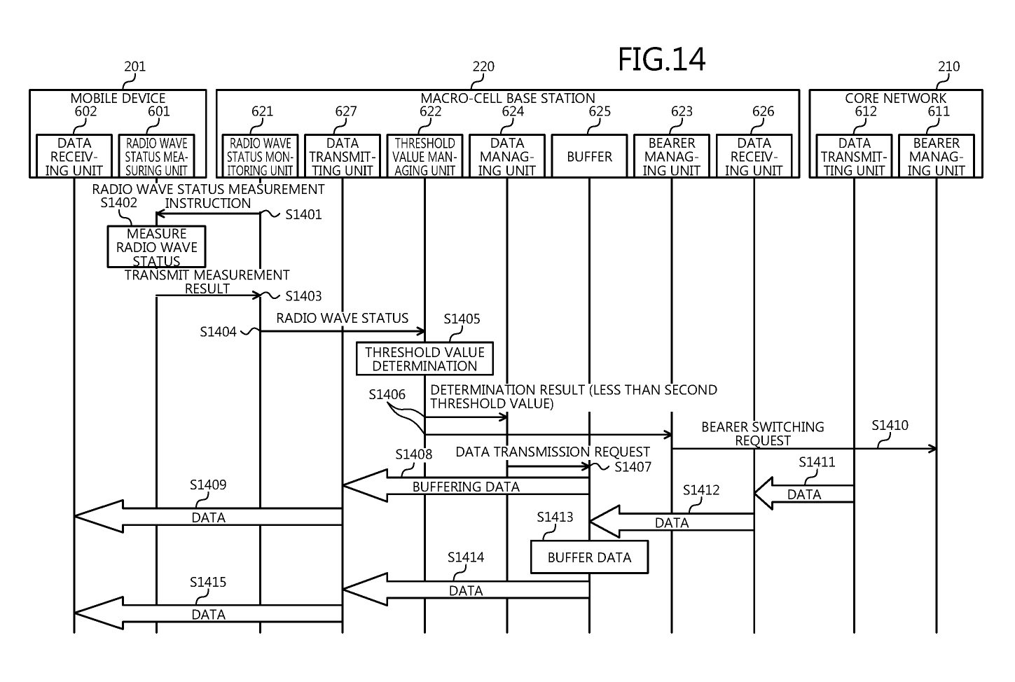

FIG. 14 is a sequence diagram of an example of a bearer switching operation. When the data transfer depicted in FIG. 12 is performed, the communications system 200 operates for the bearer switching operation as in steps depicted in FIG. 14, for example.

Steps S1401 to S1405 depicted in FIG. 14 are the same as steps S1304 to S1308 depicted in FIG. 13. However, in the example depicted in FIG. 14, it is assumed that the radio wave status is below the second threshold value (less than the second threshold value) at step 1405. After step S1405, the threshold value managing unit 622 of the macro-cell base station 220 outputs to the data managing unit 624 and the bearer managing unit 623, a determination result indicating that the radio wave status is less than the second threshold value (step S1406).

The data managing unit 624 outputs to the buffer 625, a data transmission request requesting the transmission of the buffering data (step S1407). The buffer 625 outputs the buffering data to the data transmitting unit 627 (step S1408). The data transmitting unit 627 transmits to the mobile device 201, the data (buffering data) output at step S1408 (step S1409). The data transmitted at step S1409 is received by the data receiving unit 602 of the mobile device 201.

The bearer managing unit 623 transmits to the core network 210, a bearer switching request requesting the bearer switching (step S1410). The bearer switching request transmitted at step S1410 is a request for switching the bearer used for transmission to the mobile device 201, from the bearer of the small-cell base station 230 to the bearer of the macro-cell base station 220.

The data transmitting unit 612 of the core network 210 transmits to the macro-cell base station 220, data for the mobile device 201 (step S1411). The data receiving unit 626 of the macro-cell base station 220 outputs the data output at step S1411 to the buffer 625. (step S1412).

The buffer 625 then buffers the data from the core network 210 until the transmission of the buffering data until step S1407 is completed (step S1413). When the transmission of the buffering data until step S1407 is completed, the buffer 625 outputs to the data transmitting unit 627, the data buffered at step S1413 (step S1414). This enables sequence consistency to be guaranteed between the data from the core network 210 and the buffering data.

The data transmitting unit 627 then transmits to the mobile device 201, the data output at step S1414 (step S1415). The data transmitted at step S1415 is received by the data receiving unit 602 of the mobile device 201.

At step S1410, the bearer managing unit 623 may transmit the bearer switching request also to the small-cell base station 230. In response to this request, the small-cell base station 230 releases the radio resource ensured for the bearer for the mobile device 201.

Depending on the timing of the bearer switching, the data transmitted at step S1415 may include data overlapping the data transmitted from the small-cell base station 230 to the mobile device 201. In this regard, since the synchronization is already achieved between the macro-cell base station 220 and the small-cell base station 230, the mobile device 201 may select and combine the overlapping data so as to receive the data.

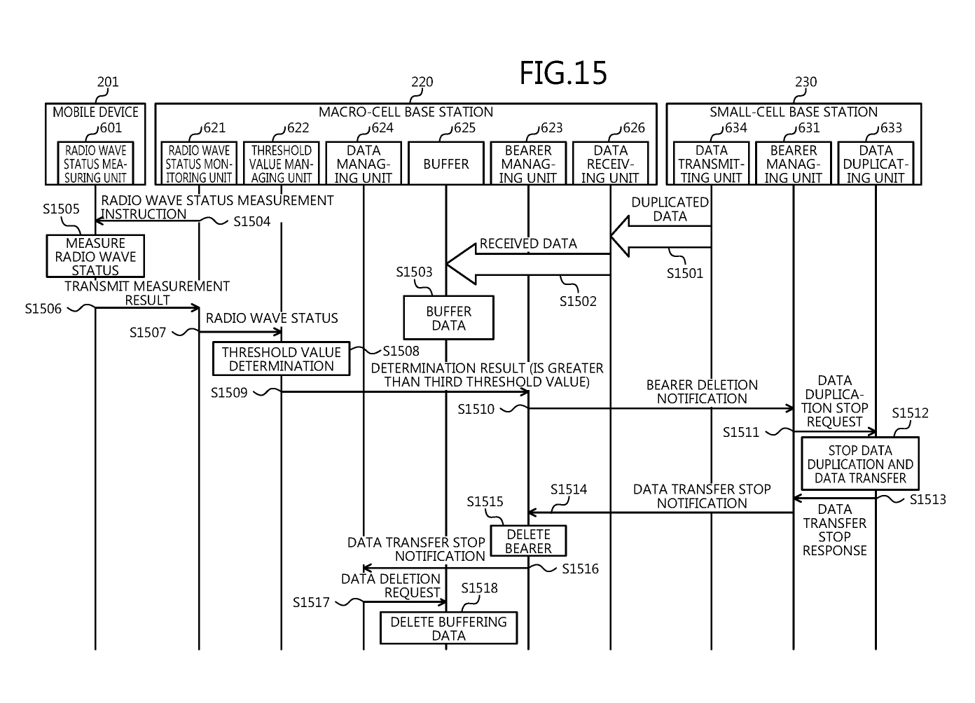

FIG. 15 is a sequence diagram of an example of a duplicated bearer releasing operation. For example, for the releasing operation of the bearer duplicated in the bearer duplicating operation depicted in FIG. 11, the communications system 200 operates as in steps depicted in FIG. 15, for example.

Steps S1501 to S1508 depicted in FIG. 15 are the same as steps S1301 to S1308 depicted in FIG. 13. However, in the example depicted in FIG. 15, it is assumed that the radio wave status exceeds the third threshold value (is greater than the third threshold value) at step S1508. Subsequently, the threshold value managing unit 622 of the macro-cell base station 220 outputs to the bearer managing unit 623, a determination result indicating that the radio wave status is greater than the third threshold value (step S1509).

The bearer managing unit 623 then transmits to the small-cell base station 230 a bearer deletion notification giving notification that the bearer is to be deleted (step S1510). The bearer managing unit 631 of the small-cell base station 230 outputs to the data duplicating unit 633, a data duplication stop request requesting the data duplication to be stopped (step S1511).

The data duplicating unit 633 stops the data duplication and the data transfer (step S1512). For example, the data duplicating unit 633 stops the data duplication at step S1203 depicted in FIG. 12 and the data transfer at step S1206 depicted in FIG. 12.

The data duplicating unit 633 outputs to the bearer managing unit 631, a data transfer stop response indicating the stop of the data transfer (step S1513). The bearer managing unit 631 transmits to the macro-cell base station 220, a data transfer stop notification giving notification of the stop of the data transfer (step S1514).

The bearer managing unit 623 of the macro-cell base station 220 then deletes the duplicated bearer (step S1515). The bearer deleted at step S1515 is the bearer set at step S1107 depicted in FIG. 11, for example. The data duplicating unit 633 transmits to the data managing unit 624, a data transfer stop notification giving notification of the stop of the data transfer (step S1516).

The data managing unit 624 outputs to the buffer 625, a data deletion request requesting the deletion of the buffering data (step S1517). The data deletion request output at step S1517 is, for example, a request for deleting all the data of the bearer deleted at step S1515, buffered in the buffer 625. The buffer 625 deletes the buffering data based on the data deletion request output at step S1517 (step S1518).

As described above, when the radio wave status in the small-cell base station 230 improves, the data transfer from the small-cell base station 230 to the macro-cell base station 220 is stopped. As a result, pressure on the traffic of the X2 interface 243 may be suppressed.

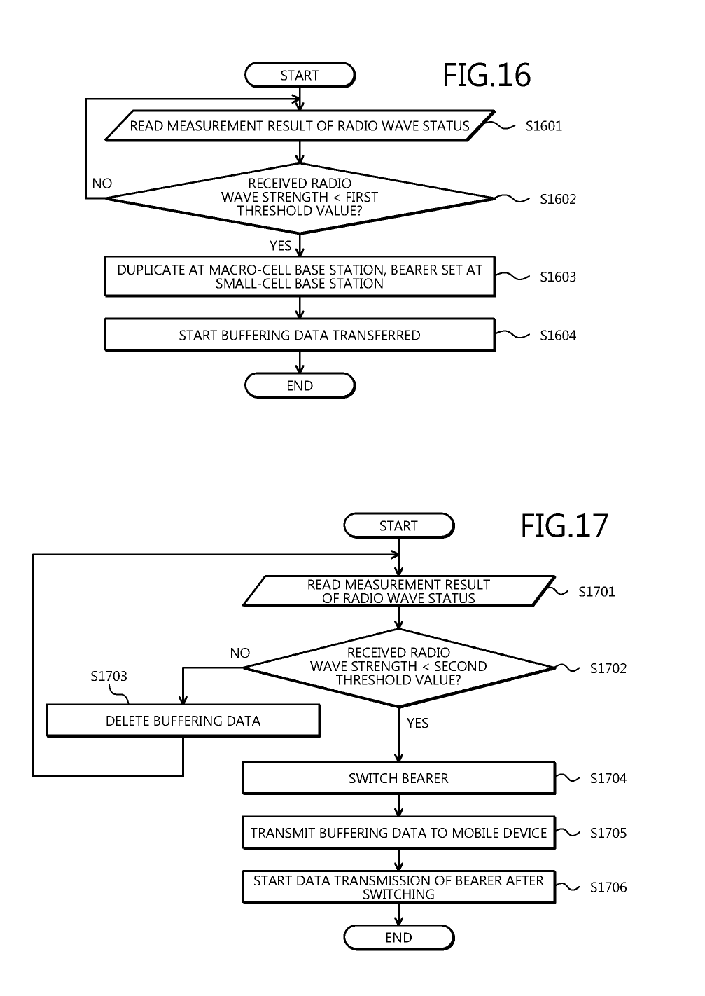

FIG. 16 is a flowchart (part one) of an example of a process by the macro-cell base station. The macro-cell base station 220 according to the second embodiment executes steps depicted in FIG. 16, for example. First, the macro-cell base station 220 reads the latest measurement result of the radio wave status (received radio wave strength) (step S1601).

The macro-cell base station 220 determines whether the received radio wave strength indicated by the measurement result read at step S1601 is less than the first threshold value (step S1602). If the received radio wave strength is equal to or greater than the first threshold value (step S1602: NO), the macro-cell base station 220 returns to step S1601.

If the received radio wave strength is less than the first threshold value (step S1602: YES), the macro-cell base station 220 duplicates at the macro-cell base station 220, the bearer of the mobile device 201 set at the small-cell base station 230 (step S1603). The macro-cell base station 220 starts buffering the data transferred from the small-cell base station 230 (step S1604).

FIG. 17 is a flowchart (part two) of an example of the process by the macro-cell base station. After step S1604 depicted in FIG. 16, the macro-cell base station 220 executes steps depicted in FIG. 17, for example.

First, the macro-cell base station 220 reads the latest measurement result of the radio wave status (received radio wave strength) (step S1701). The macro-cell base station 220 determines whether the received radio wave strength indicated by the measurement result read at step S1701 is less than the second threshold value (step S1702).

If the received radio wave strength is equal to or greater than the second threshold value (step S1702: NO), the macro-cell base station 220 goes to step S1703. In particular, the macro-cell base station 220 deletes the buffering data of the buffering started at step S1604 of FIG. 16 (step S1703) and returns to step S1701. The buffering data to be deleted at step S1703 is, for example, the data transmitted from the small-cell base station 230 until step S1701 among the buffering data.

If the received radio wave strength is less than the second threshold value at step S1702 (step S1702: YES), the macro-cell base station 220 transmits the bearer switching request to the core network 210 to switch the bearer (step S1704). In the switching of the bearer at step S1704, the bearer used for the transmission to the mobile device 201 is switched from the bearer of the small-cell base station 230 to the bearer of the macro-cell base station 220.

The macro-cell base station 220 transmits to the mobile device 201, the buffering data transferred from the small-cell base station 230 and stored in the buffer 625 (step S1705). The macro-cell base station 220 starts the data transmission of the bearer after the switching at step S1704 (step S1706).

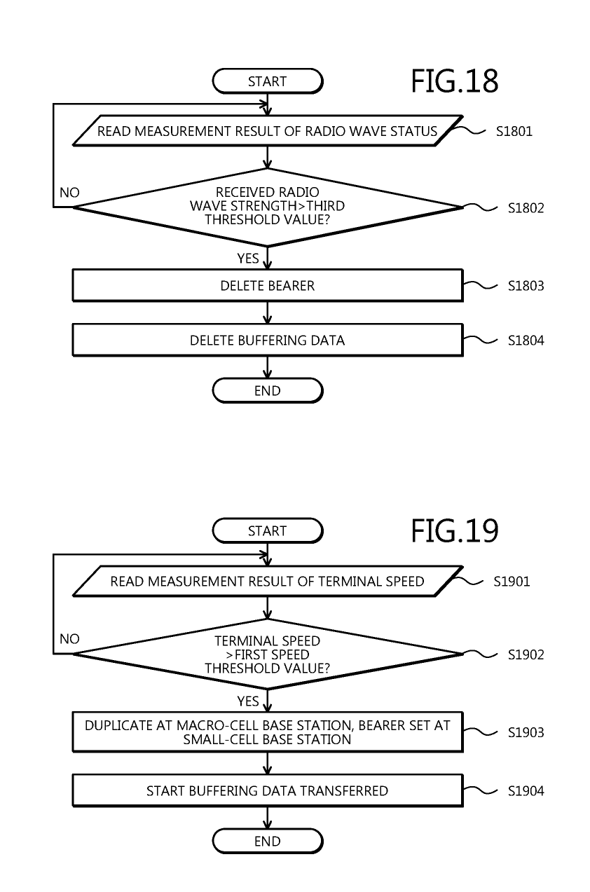

FIG. 18 is a flowchart (part three) of an example of the process by the macro-cell base station. After step S1604 depicted in FIG. 16, for example, the macro-cell base station 220 executes steps depicted in FIG. 18 concurrently with steps depicted in FIG. 17.

First, the macro-cell base station 220 reads the latest measurement result of the radio wave status (received radio wave strength) (step S1801). The macro-cell base station 220 determines whether the received radio wave strength indicated by the measurement result read at step S1801 is greater than the third threshold value (step S1802). If the received radio wave strength is equal to or less than the third threshold value (step S1802: NO), the macro-cell base station 220 returns to step S1801.

If the received radio wave strength is greater than the third threshold value at step S1802 (step S1802: YES), the macro-cell base station 220 deletes the bearer duplicated at the macro-cell base station 220 at step S1603 of FIG. 16 (step S1803). The macro-cell base station 220 then deletes the buffering data of the buffering started at step S1604 (step S1804).

As described above, according to the second embodiment, if degradation of the radio wave status (wireless quality) of the small cell 131 in the mobile device 201 is detected, the bearer of the mobile device 201 established in the small cell 231 may be duplicated at the macro cell 221. If further degradation of the wireless quality of the small cell 231 at the mobile device 201 is detected, the bearer used for the communication of the mobile device 201 may be switched to the duplicated bearer.

As a result, for example, even without moving the bearer at the time of cell switching, the cell switching may be made by switching the bearer to be used to the duplicated bearer. Therefore, the cell switching may be made in a short time and decreases in throughput may be suppressed at the time of the cell switching.

A third embodiment will be described in terms of portions different from the second embodiment. In the second embodiment, when degradation of the radio wave status of the small cell 131 at the mobile device 201 is detected, the bearer of the mobile device 201 established in the small cell 231 is duplicated in the macro cell 221 in the described configuration.

On the other hand, in the third embodiment, when an increase in movement speed of the mobile device 201 is detected, the bearer of the mobile device 201 established in the small cell 231 is duplicated at the macro cell 221. As a result, the bearer of the mobile device 201 may be duplicated in the macro cell 221 before degradation in the wireless quality of the small cell 231 at the mobile device 201 due to movement of the mobile device 201.

FIG. 19 is a flowchart (part one) of an example of a process by the macro-cell base station according to the third embodiment. The macro-cell base station 220 according to the third embodiment executes steps depicted in FIG. 19, for example. First, the macro-cell base station 220 reads the latest measurement result of the speed (terminal speed) of the mobile device 201 (step S1901). For example, the mobile device 201 measures the terminal speed and periodically transmits a measurement result to the macro-cell base station 220 so that the terminal speed may be acquired.

The macro-cell base station 220 determines whether the terminal speed indicated by the measurement result read at step S1901 is greater than a first speed threshold value (step S1902). If the terminal speed is equal to or less than the first speed threshold value (step S1902: NO), the macro-cell base station 220 returns to step S1901.

If the terminal speed is greater than the first speed threshold value at step S1902 (step S1902: YES), the macro-cell base station 220 duplicates at the macro-cell base station 220, the bearer of the mobile device 201 set at the small-cell base station 230 (step S1903). The macro-cell base station 220 starts buffering the data transferred from the small-cell base station 230 (step S1904).

After step S1904 depicted in FIG. 19, the macro-cell base station 220 according to the third embodiment executes steps depicted in FIG. 17, for example.

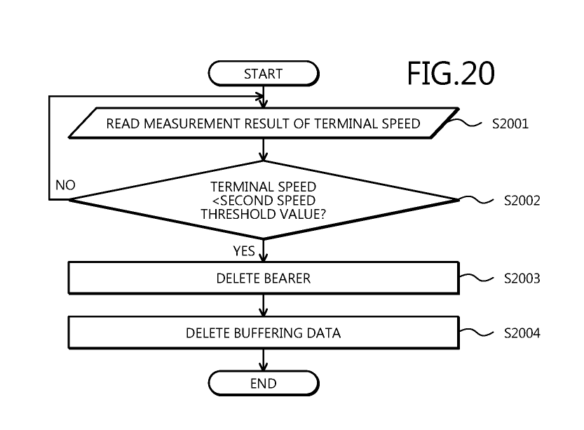

FIG. 20 is a flowchart (part two) of an example of the process by the macro-cell base station according to the third embodiment. After step S1904 depicted in FIG. 19, for example, the macro-cell base station 220 executes steps depicted in FIG. 20 concurrently with steps depicted in FIG. 17.

First, the macro-cell base station 220 reads the latest measurement result of the speed (terminal speed) of the mobile device 201 (step S2001). The macro-cell base station 220 determines whether the terminal speed indicated by the measurement result read at step S2001 is less than a second speed threshold value (step S2002). If the terminal speed is equal to or greater than the second speed threshold value (step S2002: NO), the macro-cell base station 220 returns to step S2001.

If the terminal speed is less than the second speed threshold value at step S2002 (step S2002: YES), the macro-cell base station 220 deletes the bearer duplicated at the macro-cell base station 220 at step S1903 of FIG. 19 (step S2003). The macro-cell base station 220 then deletes the buffering data of the buffering started at step S1904 (step S2004).

In this way, according to the third embodiment, if an increase in the movement speed of the mobile device 201 is detected, the bearer of the mobile device 201 established in the small cell 231 may be duplicated in the macro cell 221. As a result, the bearer of the mobile device 201 may be duplicated in the macro cell 221 before degradation in the radio wave status of the small cell 231 at the mobile device 201 due to the movement of the mobile device 201.

Therefore, for example, even without moving the bearer at the time of cell switching, the cell switching may be made by switching the bearer to be used to the duplicated bearer. Therefore, the cell switching may be made in a short time and decreases in throughput may be suppressed at the time of the cell switching.

As described above, according to the base station apparatus and the system, decreases in throughput may be suppressed at the time of the cell switching.

For example, the recent spread of high-function terminals such as smartphones leads to diversification of services utilized by using mobile terminals and an increase in the amount of communication per terminal. Additionally, traffic is expected to increase in mobile networks. As one measure against an increase in traffic, utilization of a small cell is receiving attention. A network using a small cell has a fewer number of accommodated users than a conventional macro cell and enables occupancy of a band so that a high throughput may be ensured.

On the other hand, since the small cell has a coverage area smaller than the macro cell, handout from the small cell frequently occurs, making it impossible to receive data transmitted through the small cell. Therefore, handover only to the small cell is required (allow the communication in the macro cell to continue) as is the case with a normal handover.

In this regard, the embodiments described above may provide an arrangement for reliably delivering data communicated in the small cell in the case of the handover from the small cell while maintaining the communication in the macro cell.

In the case of the normal handover under LTE, a hard handover is executed by using the S1 interface or the X2 interface. In this case, transmission data is buffered at a handover source and is then transferred to a handover destination after completion of the handover. Therefore, the throughput is temporarily reduced when the handover is executed.

On the other hand, a handover is executed without stopping data transmission in the diversity handover (DHO) under 3G; however, the same data is temporarily transmitted by both the handover source and the handover destination. Therefore, increased load occurs in a higher-level network or a wireless segment.

In this regard, according to the embodiments described above, if the radio wave status degrades in a small cell managed in a macro cell, the same bearer as the small cell may be preliminarily set in the macro cell. As a result, at the time of the handover from the small cell to the macro cell, the data buffering at the handover source and the transmission of the same data to the wireless segment may be eliminated so as to avoid decreases in throughput and increased load in the wireless segment.

Therefore, for example, in the handover from the small cell to the macro cell under an environment in which concurrent communication is performed at different nodes and different frequencies, this enables decreases in throughput to be avoided as well as loads in the higher-level network or the wireless segment.

However, the conventional techniques described above have problems in that time is required for cell switching for handover from a small cell to a macro cell, for example, and in that decreases in throughput cannot be suppressed at the time of the cell switching.

One aspect of the present invention produces an effect in that decreases in throughput at the time of the cell switching may be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station apparatus comprising:
a memory; and
a processor coupled to the memory, the processor configured to:
acquire a measurement report indicating a measurement result at a terminal apparatus connected to a first cell and a second cell, the terminal apparatus performing communication through a first bearer set in the first cell; and
based on the acquired measurement report, set in the second cell when the measurement report satisfies a first condition, a second bearer duplicated from the first bearer, and switch a bearer of communication of the terminal apparatus from the first bearer to the second bearer when the measurement report satisfies a second condition different from the first condition.

2. The base station apparatus according to claim 1, wherein
the measurement report from the terminal apparatus includes information concerning a wireless quality of the first cell at the terminal apparatus, and
the processor sets in the second cell, the second bearer duplicated from the first bearer when the wireless quality falls below a first predetermined value, and switches the bearer of communication of the terminal apparatus from the first bearer to the second bearer when the wireless quality falls below a second predetermined value lower than the first predetermined value.

3. The base station apparatus according to claim 1, wherein
the measurement report from the terminal apparatus includes information concerning a movement speed of the terminal apparatus performing communication through the first bearer set in the first cell and information concerning a wireless quality of the first cell at the terminal apparatus, and
the processor sets in the second cell, the second bearer duplicated from the first bearer when the movement speed exceeds a predetermined speed, and switches the bearer of communication of the terminal apparatus from the first bearer to the second bearer when the wireless quality falls below a predetermined value.

4. The base station apparatus according to claim 2, wherein
the processor, when the wireless quality falls below the first predetermined value, performs control causing duplicated data of data transmitted in the first cell through the first bearer to the terminal apparatus to be transmitted from a base station apparatus of the first cell to a base station apparatus of the second cell and the duplicated data to be buffered at a base station of the second cell, and
the processor, when the wireless quality falls below the second predetermined value, performs control causing the duplicated data to be transmitted from the base station apparatus of the second cell through the second bearer to the terminal apparatus.

5. The base station apparatus according to claim 4, wherein
the processor, after switching the bearer of communication of the terminal apparatus to the second bearer, causes the base station of the second cell to transmit the duplicated data through the second bearer while buffering data that is for the terminal apparatus and received from another communication apparatus, and
the processor, after transmission of the duplicated data is completed, causes the buffered data for the terminal apparatus to be transmitted through the second bearer.

6. The base station apparatus according to claim 4, wherein
the processor, after switching the bearer of communication of the terminal apparatus to the second bearer, causes among the duplicated data, data duplicated until a time point at which the wireless quality is not below the second predetermined value to be transmitted through the second bearer to the terminal apparatus.

7. The base station apparatus according to claim 6, wherein
the processor causes the duplicated data buffered by the base station of the second cell to be deleted, when the wireless quality is below the first predetermined value and is not below the second predetermined value.

8. The base station apparatus according to claim 2, wherein
the processor deletes the second bearer, when the wireless quality falls below the first predetermined value and then exceeds a third predetermined value equal to or greater than the first predetermined value.

9. The base station apparatus according to claim 4, wherein
the processor causes transmission of the duplicated data from the base station apparatus of the first cell to the base station apparatus of the second cell to be stopped, when the wireless quality falls below the first predetermined value and then exceeds a third predetermined value equal to or greater than the first predetermined value.

10. The base station apparatus according to claim 1, wherein
the base station apparatus is the base station apparatus of the second cell.

11. A system comprising:
a terminal apparatus configured to connect to a first cell and a second cell, and perform communication through a first bearer set in the first cell; and
a base station apparatus configured to set in the second cell when a measurement result in the terminal apparatus satisfies a first condition, a second bearer duplicated from the first bearer, and switch a bearer of communication of the terminal apparatus from the first bearer to the second bearer when the measurement result satisfies a second condition different from the first condition.
